(19) United States
(12) Patent Application Publication
(10) Pub. No.: US 2012/0226538 A1
(43) Pub. Date: Sep. 6, 2012

(54) ADVERTISING PRICING SYSTEM USING STRIPED AGGRESSIVE DISCOUNTING AND SHARED AUDIENCE AUCTIONS

(75) Inventors: Omar Tawakol, Los Altos, CA (US); Michael Bigby, Los Gatos, CA (US); Barry Hsiao-tung Chu, Bellevue, WA (US); Alexander Hooshmand, San Francisco, CA (US)

(73) Assignee: Blue Kai, Inc., Bellevue, WA (US)

(21) Appl. No.: 13/365,033

(22) Filed: Feb. 2, 2012

Related U.S. Application Data
(60) Provisional application No. 61/439,791, filed on Feb. 4, 2011.

(51) Int. Cl. G06Q 30/08; G06Q 30/06

(52) U.S. Cl. 705/14.23

(57) ABSTRACT

Embodiments are directed towards an advertising pricing system that uses striped aggressive discounting and shared audience auctions. A plurality of stripes is determined for an audience, where at least one stripe is assigned a different discount. Each user in the audience is associated with one of the stripes. All audience data can then be distributed to and shared between data buyers; thus, each data buyer can use the audience independent of other data buyers. In one embodiment, data buyers can provide content to individual users regardless of the stripe that is associated with the user. Data buyers can then be billed based on the stripe discount associated with each user that the data buyer provided content. In one embodiment, the number, size, and discount associated with each stripe may be modified to dynamically produce an optimum yield based on shared audience auction bidding volume using striped aggressive discounting.

### CROSS REFERENCE TO RELATED APPLICATIONS

This application claims the benefit under 35 U.S.C. §119(e) of U.S. Provisional Patent Application Ser. No. 61/439,791 filed on Feb. 4, 2011, which is incorporated herein by reference.

### TECHNICAL FIELD

The present invention relates generally to an advertising pricing system and, more particularly, but not exclusively to dynamically producing an optimum yield based on shared audience auction bidding using striped aggressive discounting.

### BACKGROUND

Today people use the Internet for all aspects of everyday life. As people use the internet, information about a person's internet usage may be monitored and stored. This information may then be used to generate profiles of each individual person's internet usage. These profiles may then be collected, aggregated and provided to advertising agencies. An advertising agency can then use the individual profiles to provide targeted advertisements.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a client device that may be included in a system such as that shown in FIG. 1;

FIG. 3 shows an embodiment of a network device that may be included in a system such as that shown in FIG. 1;

FIG. 4 illustrates a logical flow diagram generally showing one embodiment of an overview process that uses striped aggressive discounting and shared audience auctions;

FIG. 5 illustrates a logical flow diagram generally showing one embodiment of a process for billing data buyers;

FIG. 6 illustrates a logical flow diagram generally showing one embodiment of a process for dynamically producing an optimum yield;

FIG. 7A shows one example of an embodiment of a use case illustrating distributed audience data;

FIG. 7B shows one example of an embodiment of a use case illustrating distributed audience data;

FIG. 8A shows one example of an embodiment of a use case illustrating striped aggressive discounting;

FIGS. 8B-8E show various examples of embodiments of a use case illustrating modifications to striped aggressive discounting characteristics; and

FIG. 9 illustrates one example of an embodiment of a mapping of an advertising pricing system that uses striped aggressive discounting and shared audience auctions.

### DETAILED DESCRIPTION

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

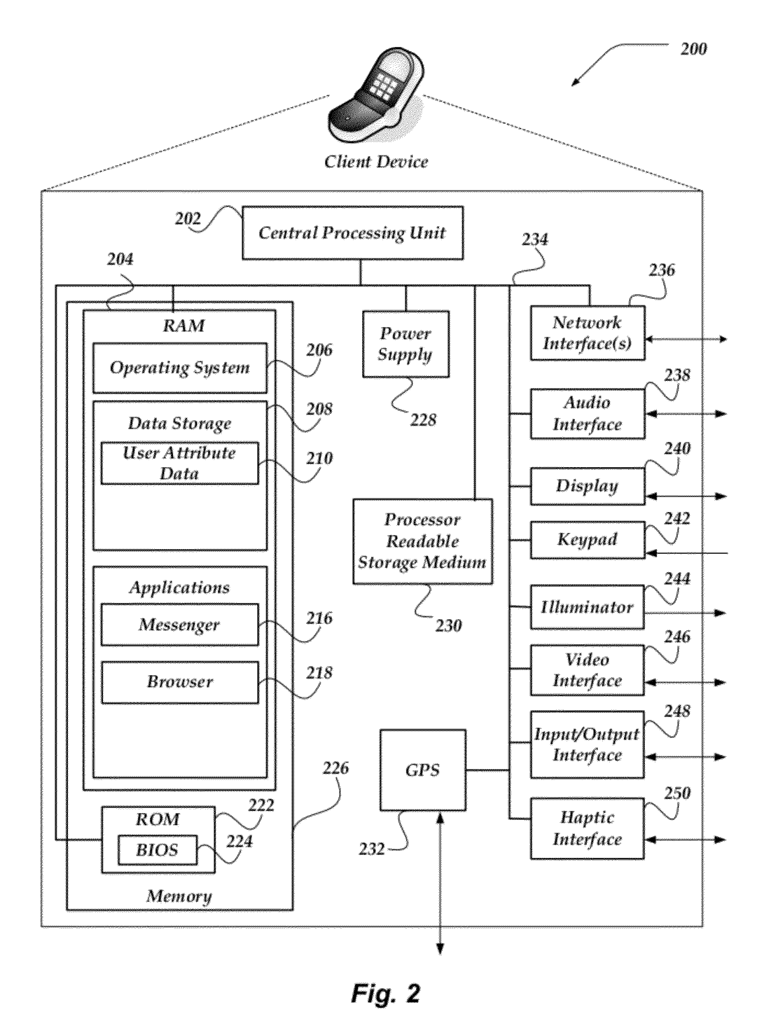

As used herein, the term “audience” refers to a collection of users of online content who have exhibited in the past or are likely to exhibit in the future at least one shared attribute. As used herein, the term “user” generally refers to an individual person and/or virtually any computing device used by a person, such as client device 200 of FIG. 2. A user can be associated with one or more audiences of online content. As used herein, the term “audience data” refers to an aggregation of data about each user of an audience.

As used herein, the term “stripe” refers to a grouping of data about one or more users of an audience, where each of the one or more users is associated with the grouping. Thus, data about each user of an audience may be associated with a single stripe of that audience.

As used herein, the term “attribute” generally refers to a user's online or offline behaviors and actions; direct or indirect communications and/or predispositions towards or predilection for certain products, events, or entities; and/or direct or indirect indications of a user's affinity, inclusion or exclusion in certain groups (e.g. demographic) or categories. Lack of a particular behavior and/or a negative affinity could also be used as an attribute. Such online behavior may include, but is not limited to, browsing, searching, purchasing, or the like.

The term attribute may also refer to campaigns seen or experienced by a user. Such campaigns may include an advertising campaign, a promotional campaign, an informational campaign, or the like. Such campaigns may be experienced by a user through online advertisements placed on web sites or other web services, including email, SMS, IM messages or the like; or other offline advertisements in virtually any medium, including but not limited to television, radio, print, physical displays, and the like.

As used herein, the term “content” refers to any online information and/or data that can be provided to a user including textual, graphical, and/or audio content. This online content may include video, images, animation, audio files, texts, instant messages, emails, documents, posters, letters, or the like that can be used for promotions, advertisements, distribution of product information, discounts, coupons, or the like.

As used herein, the term “data buyer” refers to any entity, individual, partnership, company, business, or the like that may buy, rent, lease, bid, and/or otherwise obtain access to audience data for use in distributing content, including online content, to the users of the audience.

As used herein, the term “category” generally refers to a subject classification and/or a topic of content provided to a user. In one non-limiting example, a data buyer may provide content about a category “hotels” to a user who is interested in traveling to Las Vegas, Nev. Further, categories may be associated with broad classification types relating to particular markets for goods and/or services. In one non-limiting example, a data buyer may provide content about a category “travel” to a user who is interested in traveling to Las Vegas, Nev.

The term “category” may also refer to a type of content provided to users of an audience, such as advertisements, product information, coupons, discounts, or the like. Additionally, the term category may refer to both a subject and type of content provided to users of an audience. For example, one category may be “travel coupons,” which may include coupons for limousine services.

As used herein, the phrase “shared audience auction” refers to a process of providing information to a plurality of data buyers, where each of the plurality of data buyers receive, see and have access to all of the audience data prior to purchasing and/or bidding on any audience data. Each data buyer can use the audience data independent of other data buyers. In a shared audience auction, data buyers may not directly bid against each other as they would in a conventional auction. Rather, all data buyers share the audience data and have the ability to bid on any of the audience data independent of the other data buyers.

As used herein, the phrase “shared audience auction bid” refers to a data buyer using audience data from a shared audience auction to provide content to a user of an audience. Thus, using audience data indicates a bid for the used audience data. As used herein, the phrase “shared audience auction bidding volume” refers to a total number of users that are associated with a stripe who receive content from data buyers using a shared audience auction.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, the present invention is directed towards controlling data buyer usage of audience data by dividing the audience data into differently priced stripes that may be of different sizes. One way to control usage of data is to limit a number of data buyers who can use the data, i.e. keep the data to an exclusive number of data buyers. Limiting the number of data buyers can be accomplished by selling the data exclusively to one or two data buyers. However, embodiments of the present invention teach a system and methods for limiting usage to certain portions of audience data, e.g. stripes of audience data, by providing the audience data to all data buyers, while controlling characteristics of the stripes, such as the number, size and price of each stripe.

When two (or more) similar stripes of data are priced differently, e.g. a cheaper stripe and an expensive stripe, data buyers tend to choose data from the cheaper stripe because that data is cheaper than the data from the expensive stripe. Consequentially, a higher number of data buyers may choose data from the cheaper stripe than the number of data buyers that choose data from the expensive stripe. As a result, the expensive stripe of data becomes more exclusive than the cheaper stripe because fewer data buyers chose the expensive stripe compared to the cheaper stripe. Similarly, a number and/or size of the stripes may further influence data buyers. For example, as the size of one stripe increases, there is a possibility that more data buyers will use data from that stripe, which may result in a decrease in the exclusivity of the data from that stripe.

Data buyers can use data from any of the stripes. Similarly, data buyers may not be restricted from using data from one stripe or another stripe. Therefore, a data buyer may choose data from one stripe because the data buyer knows that there will be fewer data buyers that choose that stripe compared to another stripe. At the same time, a data buyer may also choose data from a less expensive stripe to save money. As data buyers use data from the stripes, the size, number, and/or price of each stripe may be modified to influence how the data buyers use the stripes.

Embodiments of the present invention can control the usage of audience data by using striped aggressive discounting and shared audience auctions. Striped aggressive discounting determines a plurality of stripes for audience data. Each stripe is assigned a price discount, where at least one stripe is assigned a different discount on price than another stripe, i.e. using the data from one stripe may cost more than using data from a different stripe. Data about each user in the audience is associated with one of the stripes.

Shared audience auctioning can distribute all of the audience data to a plurality of data buyers. The data buyers share the audience data, so that each data buyer can use the audience data independent of other data buyers. In one embodiment, data buyers can use the audience data to provide content, including online content, to individual users regardless of which stripe the user is associated. Data buyers can be billed based on the stripe discount associated with each user that the data buyer provided content. In some embodiments, an optimum yield may occur when a shared audience auction bidding volume for each of a plurality of stripes is above a minimum threshold value. In one embodiment, a number, size, and/or discount associated with each stripe may be modified to dynamically produce the optimum yield based on shared audience auction bidding using striped aggressive discounting. In another embodiment, at least one of the plurality of stripes may be modified to include at least one user attribute limitation.

### Illustrative Operating Environment

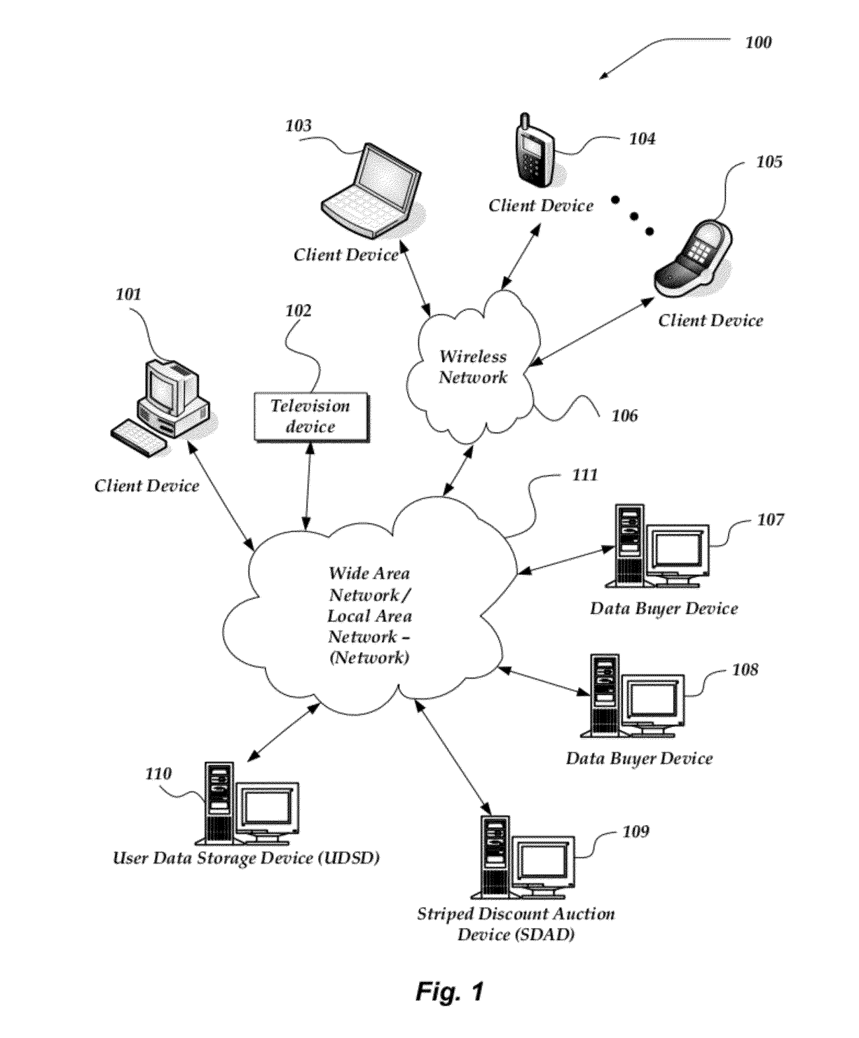

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 111, wireless network 106, client devices 101-105, data buyer devices 107-108, Striped Discount Auction Device (SDAD) 109, and User. Data Storage Device (UDSD) 110.

One embodiment of client devices 101-105 is described in more detail below in conjunction with FIG. 2. Generally, however, client devices 103-105 may include virtually any portable computing device capable of receiving and sending a message over a network, such as network 111, wireless network 106, or the like. Client devices 103-105 may also be described generally as client devices that are configured to be portable. Thus, client devices 103-105 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, client devices 103-105 typically range widely in terms of capabilities, and features. In one non-limiting example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Client device 101 may include virtually any computing device capable of communicating over a network to send and receive information performing various online activities, or the like. The set of such devices may include devices that typically connect using a wired or wireless communications medium such as personal computers, multiprocessor systems, microprocessor-based or programmable consumer electronics, network PCs, or the like. In one embodiment, at least some of client devices 101-105 may operate over wired and/or wireless network. Client device 102 may include virtually any device useable as a television device. Today, many of these devices include a capability to access and/or otherwise communicate over a network such as network 111 and/or even wireless network 106. Moreover, client device 102 may access various computing applications, including a browser, or other web-based application.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the client device may employ the browser application to perform various activities over a network (online). However, another application may also be used to perform various online activities.

Client devices 101-105 also may include at least one other client application that is configured to receive and/or send content between another computing device. The client application may include a capability to provide and receive media content, textual content, graphical content, audio content, and the like. In some embodiments, the client application may include a capability to allow UDSD 110 to monitor and/or store audience data, including attributes, about client devices 101-105, about users of client devices 101-105, and/or provided by users of client devices 101-105. In other embodiments, the client application may be configured to receive content, including advertisements and other online content, from SDAD 107-108. In one embodiment, a user of client devices 101-105 may interact with the received online content by selecting, clicking, or the like, on the received online content, such as a click through advertisement. Such interactions may be provided to UDSD 110 as further attributes about the user.

The client application may further provide information that identifies itself, including a type, capability, name, and the like. In one embodiment, client devices 101-105 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a network packet, or the like, sent between other client devices, UDSD 110, data buyer devices 107-108, and/or other computing devices.

Client devices 101-105 may further be configured to include a client application that enables an end-user to log into an end-user account that may be managed by another computing device, such as UDSD 110, data buyer devices 107-108, or the like. Such end-user account, in one non-limiting example, may be configured to enable the end-user to manage one or more online activities, including in one non-limiting example, search activities, social networking activities, browse various websites, make purchases, sell products/services, communicate with other users, or share attachments with others, or the like. However, participation in such online networking activities may also be performed without logging into the end-user account.

Wireless network 106 is configured to couple client devices 103-105 and its components with network 111. Wireless network 106 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like. In one embodiment, the system may include more than one wireless network.

Wireless network 106 may further include an autonomous system of terminals, gateways, routers, and the like connected by wireless radio links, and the like. These connectors may be configured to move freely and randomly and organize themselves arbitrarily, such that the topology of wireless network 106 may change rapidly.

Wireless network 106 may further employ a plurality of access technologies including 2nd (2G), 3rd (3G), 4th (4G) generation radio access for cellular systems, WLAN, Wireless Router (WR) mesh, and the like. Access technologies such as 2G, 3G, 4G and future access networks may enable wide area coverage for mobile devices, such as client devices 103-105 with various degrees of mobility. In one non-limiting example, wireless network 106 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 106 may include virtually any wireless communication mechanism by which information may travel between client devices 103-105 and another computing device, network, and the like.

Network 111 is configured to couple network devices with other computing devices, including, UDSD 110, SDAD 109, data buyer devices 107-108, client devices 101 and 102, and through wireless network 106 to client devices 103-105. Network 111 is enabled to employ any form of computer-readable media for communicating information from one electronic device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In one embodiment, network 111 may be configured to transport information of an Internet Protocol (IP). In essence, network 111 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

UDSD 110 includes virtually any network device usable to operate as website servers to provide and/or receive information from client devices 101-105. Such information may include, but is not limited to textual, graphical, and/or audio content, and/or any of a variety of media content for access by, or any of a variety of other interactions with the media content by, another client device. UDSD 110 may also operate as a messaging server such as an SMS message service, IM message service, email message service, alert service, or the like. Moreover, UDSD 110 may also operate as a File Transfer Protocol (FTP) server, a database server, music and/or video download server, or the like.

Additionally, UDSD 110 may be configured to perform multiple functions. In some embodiments, UDSD 110 may detect, receive, or otherwise monitor communications and/or information, including attributes, about client devices 101-105, users, and/or other data and actions provided by users of client devices 101-105. The communications may include, for example, searches for a particular topic, online purchases, or the like. In other embodiments, UDSD 110 may be configured to include a capability to monitor and/or store audience data, including attributes. In other embodiments, UDSD 110 may be configured to include a capability to provide information and/or data, including audience data to SDAD 109, data buyer devices 107-108, or the like. In yet other embodiments, UDSD 110 may provide access to audience data to SDAD 109 and or data buyer devices 107-108.

Devices that may operate as UDSD 110 include various network devices, including, but not limited to personal computers, desktop computers, multiprocessor systems, microprocessor-based or programmable consumer electronics, network PCs, server devices, network appliances, and the like.

Although FIG. 1 illustrates UDSD 110 as a single computing device, the invention is not so limited. For example, one or more functions of the UDSD 110 may be distributed across one or more distinct network devices.

Moreover, UDSD 110 is not limited to a particular configuration. Thus, in one embodiment, UDSD 110 may contain a plurality of network devices to receive, maintain, and/or store audience data. Similarly, in another embodiment, UDSD 110 may contain a plurality of network devices that operate using a master/slave approach, where one of the plurality of network devices of UDSD 110 operates to manage and/or otherwise coordinate operations of the other network devices. In other embodiments, the UDSD 110 may operate as a plurality of network devices within a cluster architecture, a peer-to-peer architecture, and/or even within a cloud architecture. Thus, the invention is not to be construed as being limited to a single environment, and other configurations, and architectures are also envisaged.

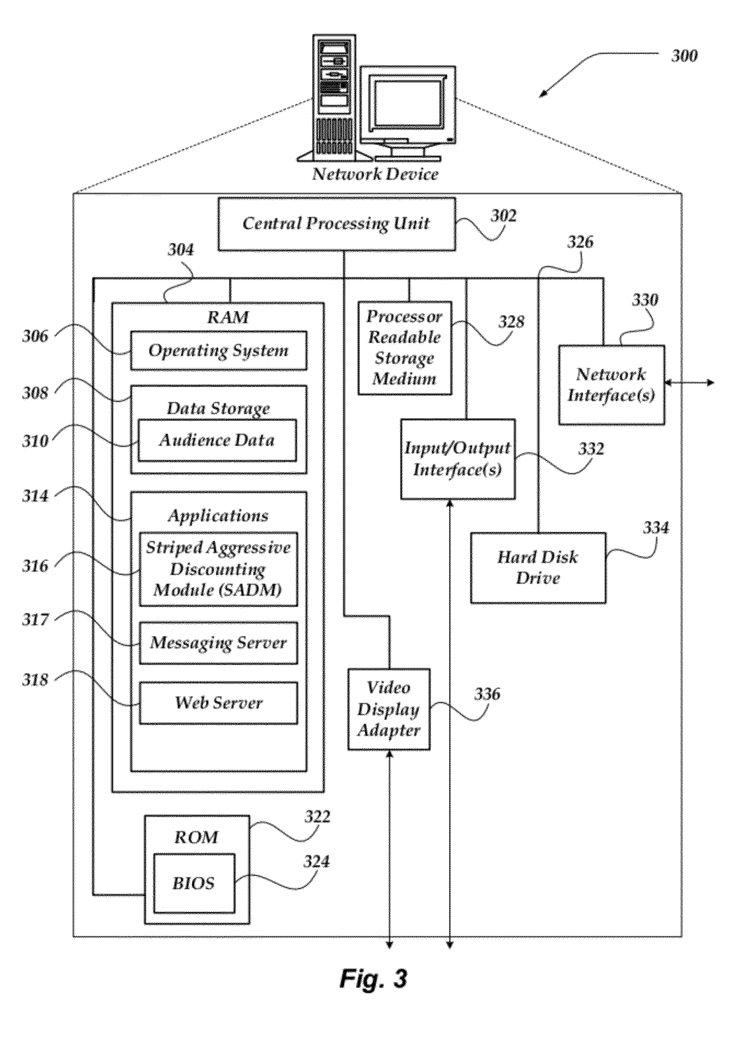

One embodiment of SDAD 109 is described in more detail below in conjunction with FIG. 3. Briefly, however, SDAD 109 may include any computing device capable of connecting to network 111 to receive data, including audience data, from UDSD 110, generate and modify striped aggressive discounting for audience data, and distribute the audience data to data buyers, such as data buyer devices 107-108 for shared audience auctions. Additionally, SDAD 109 may be capable of receiving reports and billing information from data buyer devices 107-108.

Moreover, SDAD 109 is not limited to a particular configuration. Thus, in one embodiment, SDAD 109 may contain a plurality of network devices to generate striped aggressive discounting for audience data and distribute the audience data to data buyers, such as data buyer devices 107-108 for shared audience auctions. Similarly, in another embodiment, SDAD 109 may contain a plurality of network devices that operate using a master/slave approach, where one of the plurality of network devices of SDAD 109 operates to manage and/or otherwise coordinate operations of the other network devices. In other embodiments, the SDAD 109 may operate as a plurality of network devices within a cluster architecture, a peer-to-peer architecture, and/or even within a cloud architecture. Thus, the invention is not to be construed as being limited to a single environment, and other configurations, and architectures are also envisaged.

Devices that may operate as data buyer devices 107-108, include various network devices, including, but not limited to personal computers, desktop computers, multiprocessor systems, microprocessor-based or programmable consumer electronics, network PCs, server devices, network appliances, and the like. Additionally, data buyer devices 107-108 may include any computing device capable of connecting to network 111 to receive audience data from SDAD 109, perform shared audience auction bids, provide reporting to SDAD 109, receive billing from SDAD 109, or the like. In one embodiment, a shared audience auction bid may occur when a data buyer, such as data buyer device 107 or data buyer device 108, provides content, such as online content, to a user of an audience, such as to a user of client devices 101-105. In one embodiment, a shared audience auction bid may occur when a data buyer, such as an advertising agency provides an advertisement to a user of an audience. In some embodiments, reporting to SDAD 109 may be per impression and/or per click. An impression may occur when a data buyer provides content to a user of the audience. A click may refer to an interaction between a user and online content, such as the user clicking on the advertisement to see more information. In one embodiment, the reporting to SDAD 109 may be at a category-level. In another embodiment, the reporting to SDAD 109 may be at a user-level. Thus, the reports may provide information based on various metrics, including cost per impression (CPM), cost per click (CPC), cost per lead (CPL), cost per sale (CPS), or any of a variety of other metrics.

Data buyer devices 107-108 includes virtually any network device usable to operate as website servers to provide content, including, advertisements, to client devices 101-105. Such content may include, but is not limited to textual, graphical, and/or audio content, and/or any of a variety of media content for advertising, marketing or any of a variety of media content distribution services.

Although FIG. 1 illustrates data buyer devices 107-108 as two computing devices, the invention is not so limited. For example, one or more functions of the data buyer devices 107-108 may be distributed across one or more distinct network devices. Furthermore, one or more data buyer devices 107-108 may be distributed across multiple data buyers that provide web services, such as advertising to users, such as users of client devices 101-105.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-105 of FIG. 1.

As shown in the figure, client device 200 includes a processing unit (CPU) 202 in communication with a mass memory 226 via a bus 234. Client device 200 also includes a power supply 228, one or more network interfaces 236, an audio interface 238, a display 240, a keypad 242, an illuminator 244, a video interface 246, an input/output interface 248, a haptic interface 250, and an optional global positioning systems (GPS) receiver 232. Power supply 228 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 236 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, General Packet Radio Service (GPRS), WAP, ultra wide band (UWB), IEEE 802.16 Worldwide Interoperability for Microwave Access (WiMax), SIP/RTP, or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action. Display 240 may be a liquid crystal display (LCD), gas plasma, light emitting diode (LED), or any other type of display used with a computing device. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images. Illuminator 244 may provide a status indication and/or provide light. Illuminator 244 may remain active for specific periods of time or in response to events. For example, when illuminator 244 is active, it may backlight the buttons on keypad 242 and stay on while the client device is powered. Also, illuminator 244 may backlight these buttons in various patterns when particular actions are performed, such as dialing another client device. Illuminator 244 may also cause light sources positioned within a transparent or translucent case of the client device to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client device 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like. Haptic interface 250 is arranged to provide tactile feedback to a user of the client device. For example, the haptic interface 250 may be employed to vibrate client device 200 in a particular way when another user of a computing device is calling.

Optional GPS transceiver 232 can determine the physical coordinates of client device 200 on the surface of the Earth, which typically outputs a location as latitude and longitude values. GPS transceiver 232 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 232 can determine a physical location within millimeters for client device 200; and in other cases, the determined physical location may be less precise, such as within a meter or significantly greater distances. In one embodiment, however, mobile device 200 may through other components, provide other information that may be employed to determine a physical location of the device, including for example, a MAC address, IP address, or the like.

Mass memory 226 includes a RAM 204, a ROM 222, and other storage means. Mass memory 226 illustrates an example of computer-readable storage media (devices) for storage of information such as computer-readable instructions, data structures, program modules or other data. Client device 200 may also include separate processor readable storage medium 230. Mass memory 226 stores a basic input/output system (“BIOS”) 224 for controlling low-level operation of client device 200. The mass memory also stores an operating system 206 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Mass memory 226 further includes one or more data storage 208, which can be utilized by client device 200 to store, among other things, applications 214 and/or other data. For example, data storage 208 may also be employed to store information that describes various capabilities of client device 200. The information may then be provided to another device based on any of a variety of events, including being sent as part of a header during a communication, sent upon request, or the like. Data storage 208 may also be employed to store social networking information including address books, buddy lists, aliases, user profile information, or the like. Further, as illustrated, data storage 208 may also store messages, web page content, or the like. At least a portion of the information may also be stored on a disk drive or other computer-readable storage device (not shown) within client device 200.

Data storage 208 may further store user attribute data 210. User attribute data 210 may include a demographic of a user of client device 200, information about client device 200, actions of a user of client device 200, other attributes of client device 200 and/or users of client device 200, or the like, which can be provided to and/or received by UDSD 110 of FIG. 1. Applications 214 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications 214 may include, for example, messenger 216, browser 218.

Messenger 216 may be configured to manage a messaging session using any of a variety of messaging communications including, but not limited to email, Short Message Service (SMS), Instant Message (IM), Multimedia Message Service (MMS), interne relay chat (IRC), mIRC, RSS feeds, and/or the like. For example, in one embodiment, messenger 216 may be configured as an IM application, such as AOL Instant Messenger, Yahoo! Messenger, .NET Messenger Server, ICQ, or the like. In one embodiment, messenger 216 may be configured to include a mail user agent (MUA) such as Elm, Pine, MH, Outlook, Eudora, Mac Mail, Mozilla Thunderbird, or the like. In another embodiment, messenger 216 may be a client application that is configured to integrate and employ a variety of messaging protocols, including, but not limited to various push and/or pull mechanisms for client device 200. In one embodiment, messenger 216 may interact with browser 218 for managing messages. As used herein, the term “message” refers to any of a variety of messaging formats, or communications forms, including but not limited to email, SMS, IM, MMS, IRC, or the like.

In some embodiments, messenger 216 may be configured to allow UDSD 110 of FIG. 1 to monitor and/or store audience data as attributes about client device 200 and/or provided by users of client device 200. In other embodiments, the messenger 216 may be configured to receive content, including advertisements and/or other online content, from data buyer devices 107-108 of FIG. 1 via email, instant messages, or the like. In one non-limiting example, messenger 216 may receive an email that contains advertisements.

Browser 218 may include virtually any application configured to receive and display graphics, text, multimedia, and the like, employing virtually any web based language. In one embodiment, the browser application is enabled to employ Handheld Device. Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. However, any of a variety of other web-based languages may be employed.

In one embodiment, browser 218 may enable data buyer devices 107-108 of FIG. 1 to provide online content including marketing information, product information, advertisements, discounts, coupons or the like to browser 218 for display to a user of client device 200 using display 240. In another embodiment, browser 218 and/or messenger 216 may provide and/or enable UDSD 110 of FIG. 1 to access information about client device 200 and/or users of client device 200, such as, but not limited to, user search behavior, user online purchase behavior, and/or other attributes.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may be configured to operate as a server, client, peer, or any other device. Network device 300 may represent, for example data buyer devices 107-108, SDAD 109, UDSD 110 of FIG. 1, or a combination of data buyer devices 107-108, SDAD 109, UDSD 110.

Network device 300 includes processing unit 302, video display adapter 336, input/output interface(s) 332, and a mass memory, all in communication with each other via bus 326. The mass memory generally includes RAM 304, ROM 322 and one or more permanent mass storage devices, such as hard disk drive 334, tape drive, optical drive, and/or floppy disk drive. The mass memory stores operating system 306 for controlling the operation of network device 300. Any general-purpose operating system may be employed. Basic input/output system (“BIOS”) 324 is also provided for controlling the low-level operation of network device 300. As illustrated in FIG. 3, network device 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

The mass memory as described above illustrates another type of computer-readable media, namely computer-readable storage media and/or processor-readable storage medium. Computer-readable storage media (devices) may include volatile, nonvolatile, removable, and non-removable media implemented in any method or technology for storage of information, such as computer-readable instructions, data structures, program modules, or other data. Examples of computer-readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

As shown, data storage 308 may include a database, text, spreadsheet, folder, file, or the like, that may be configured to maintain and store user account identifiers, user profiles, email addresses, IM addresses, and/or other network addresses; or the like. Data stores 308 may further include program code, data, algorithms, and the like, for use by a processor, such as central processing unit (CPU) 302 to execute and perform actions. In one embodiment, at least some of data store 308 might also be stored on another component of network device 300, including, but not limited to processor-readable storage medium 328, hard disk drive 334, or the like. Data storage 308 may further store audience data 310.

Audience data 310 may include user data obtained from users of client devices 101-105 of FIG. 1 and/or provided by UDSD 110 of FIG. 1. In one embodiment, audience data 310 may include audience data, including user attributes. In another embodiment, audience data 310 may include user attributes and billing information about each user. In other embodiments, audience data 310 may include striped aggressive discounting information, such as a discount for each stripe and an indication of an association between data about a user and a stripe. In one embodiment, audience data 310 may include use category information, such as billing information or limitations.

The mass memory also stores program code and data. One or more applications 314 are loaded into mass memory and run on operating system 306. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Striped aggressive discounting module 316, messaging server 317, and web server 318 may also be included as application programs within applications 314.

Messaging server 317 may include virtually any computing component or components configured and arranged to forward messages from message user agents, and/or other message servers, or to deliver messages to a local message store, such as data storage 308, or the like. Thus, messaging server 317 may include a message transfer manager to communicate a message employing any of a variety of email protocols, including, but, not limited, to Simple Mail Transfer Protocol (SMTP), Post Office Protocol (POP), Internet Message Access Protocol (IMAP), NNTP, or the like. Messaging server 317 may also be managed by one or more components of messaging server 317. Thus, messaging server 317 may also be configured to manage SMS messages, IM, MMS, IRC, RSS feeds, mIRC, or any of a variety of other message types. In one embodiment, messaging server 317 may enable users to initiate and/or otherwise conduct chat sessions, VOIP sessions, or the like.

In one embodiment, messaging server 317 may receive information a from another network device, such as a client device 200 of FIG. 2, or the like. In another embodiment, messaging server 317 may receive content, including advertisements and/or other online content, from another network device. Messaging server 317 may provide the content, a content platform for interacting with the content, or the like to another network device, such as client device 200 of FIG. 2.

Web server 318 represent any of a variety of services that are configured to provide content, including messages and/or other online content, over a network to another computing device. Thus, web server 318 includes, for example, a web server, a File Transfer Protocol (FTP) server, a database server, a content server, or the like. Web server 318 may provide the content including messages over the network using any of a variety of formats including, but not limited to WAP, HDML, WML, SMGL, HTML, XML, cHTML, xHTML, or the like.

In one embodiment, web server 318 may be configured to provide online content including marketing information, product information, advertisements, discounts, coupons or the like to another computing device, such as client device 200 of FIG. 2. In another embodiment, web server 318 and/or messaging server 317 may be configured to receive information from another network device, such as client device 200 of FIG. 2. In one embodiment, such information may include user attributes or the like, which may then be stored in data storage 308.

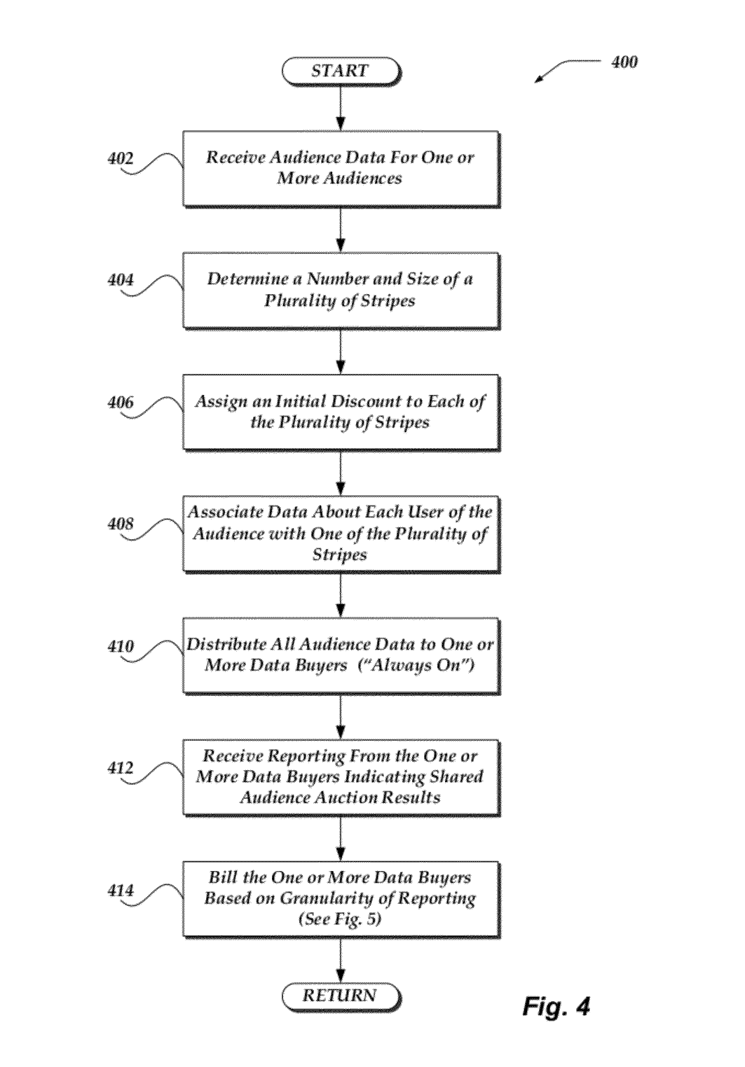

Striped Aggressive Discounting Module (SADM) 316 may include virtually any computing component or components configured and arranged to receive audience data, determine a number and size of a plurality of stripes, associate data about users of an audience to one of the plurality of stripes, assign discounts to each stripe, distribute the audience data to data buyers, receive reporting information from data buyers, manage billing of the audience data, and modify stripe discount characteristics to dynamically produce an optimum yield. In one embodiment, SADM 316 may include tracking capabilities so that data buyers, including data buyer devices 107-108 of FIG. 1, can track which users are provided content. Similarly, SADM 316 may include reporting capabilities between data buyer devices 107-108 of FIG. 1 and SDAD 109 of FIG. 1. In any event, SADM 316 may perform actions such as those described below in conjunction with FIGS. 4-9.

### General Operation

The operation of certain aspects of the invention will now be described with respect to FIGS. 4-6. FIG. 4 illustrates a logical flow diagram generally showing one embodiment of an overview process that uses striped aggressive discounting and shared audience auctions. In some embodiments, process 400 of FIG. 4 may be implemented by and/or executed on a single network device, such as network device 300 of FIG. 3. In other embodiments, process 400 or portions of process 400 of FIG. 4 may be implemented by and/or executed on a plurality of network devices, such as network device 300 of FIG. 3.

Process 400 begins, after a start block, at block 402 where audience data is received for one or more audiences. Although the invention is primarily described with reference to an audience, the invention is not so limited; rather audience data for one audience or audience data for a plurality of audiences may be received. In one embodiment, the received audience data may include data about users of an audience who share a single attribute. In another embodiment, the received audience data may include data about users of an audience who share a plurality of attributes. For example, a plurality of users may share a first attribute for searches for airline flights to Las Vegas, Nev. and a second attribute for visiting rental car website “XYZ Rentals.”

The audience data may be configured to allow data buyers easy access to the data so that the data buyers can use and manipulate the data and provide a user with content, such as, but not limited to, online content. Data buyers, also referred to as customers to the audience data, may include advertising companies, marketing companies, or the like.

Proceeding next to block 404, a plurality of stripes is determined. A number and size of each of the plurality of stripes may be determined. In some embodiments, a random number of stripes may be determined. In other embodiments, the number of stripes may be based on a number of users of the audience for the received audience data. In one embodiment, three stripes may be determined. In some embodiments, the number of stripes can be changed to reflect ongoing shifts in data buyer demand for audience, data. In one embodiment, the number of stripes can be changed to reflect ongoing shifts in data buyer demand based on shared audience auction bidding.

Along with determining the number of stripes at block 404, a size of each stripe is determined. The size of a stripe may be the number of users associated with that stripe. In some embodiments, a random size for each of the plurality of stripes may be determined based on a total number of users of the audience. In other embodiments, the size of each of the plurality of stripes may be based on a percentage of the total number of users of an audience. In one embodiment, the size of each of the plurality of stripes may be substantially similar. In another embodiment, one or more of the plurality of stripes may have a different size than another stripe. In some embodiments, the size of one or more of the plurality of stripes may be based on a pricing discount associated with the one or more of the plurality of stripes. For example, a stripe with a fewest number of users compared to other stripes may have a smaller pricing discount than the other stripes.

In some embodiments, the number and size of the plurality of stripes may be based on a total number of users of an audience. In other embodiments, the number and size of the plurality of stripes may be based on a granularity of the attributes shared by the users of the audience, such as how specific is the attribute. In other embodiments, other user attributes may be used to determine the number and size of the plurality of stripes. In one embodiment, the number and size of the plurality of stripes may be determined based on a lapse time. The lapse time may be an amount of time since a last occurrence of an attribute. In another embodiment, the number and size of the plurality of stripes may be determined based on a frequency of an attribute. These embodiments are not to be limiting, but rather it is envisioned that the number and size of the plurality of stripes may be based on other user attributes known to those skilled in the art. For example, age of the users, gender of the users, other demographic characteristics, types of advertisements viewed by the users, or the like, may be used to determine a number and/or size of a plurality of stripes.

Process 400 proceeds to block 406, where each of the plurality of stripes is assigned an initial discount. At least one stripe may be assigned a different initial discount from another stripe in the plurality of stripes. A discount may refer to a deduction from a set price for providing content to a user. As a result, providing content to users associated with one stripe may cost more than providing the same content to users associated with a different stripe. In one embodiment, the discount may be a percent reduction from the set price. In another embodiment, the discount may be an exact amount to be subtracted from the set price.

In some embodiments, a random discount may be assigned to each of the plurality of stripes. In other embodiments, a set discount may be assigned to each of the plurality of stripes. In yet other embodiments, a random discount may be assigned to at least one of the plurality of stripes and a set discount may be assigned to at least one of the plurality of stripes. In one embodiment, a discount for each of the plurality of stripes may be based on a number and/or size of each of the plurality of stripes.

Although the description of the invention primarily refers to a discount as being a deduction from a set price, the invention is not so limited. Rather, in some embodiments, one or more of the plurality of stripes may be assigned a set price for providing content to users associated with the one or more of the plurality of stripes.

In other embodiments, the discount of each of the plurality of stripes may be based on different attributes. In one embodiment, the discount may be based on a granularity of the attribute associated with the audience data. In some embodiments, the discount of one or more of the plurality of stripes may be based on an attribute that is shared between users associated with the one or more of the plurality of stripes and is not shared with users associated with other stripes.

Process 400 next proceeds to block 408, where data about each user of the audience is associated with one of the plurality of stripes. Data about each user of the audience may be associated with any one of the plurality of stripes. Thus, the distinction between data about a user associated with one stripe and data about a user associated with another stripe may be the discount assigned to the corresponding stripes.

In one embodiment, data about each user may be randomly associated with one of the plurality of stripes, such that the number of users associated with a stripe is equal to a size of the stripe. In another embodiment, data about each user may be randomly associated with one of the plurality of stripes, where the size of each of the plurality of stripes is determined by the random association of users. In other embodiments, the association between data about each user and each stripe may be based on user attributes. In one embodiment, data about each user associated with one of the plurality of stripes may share an additional attribute that is not shared by data about users associated with another stripe.

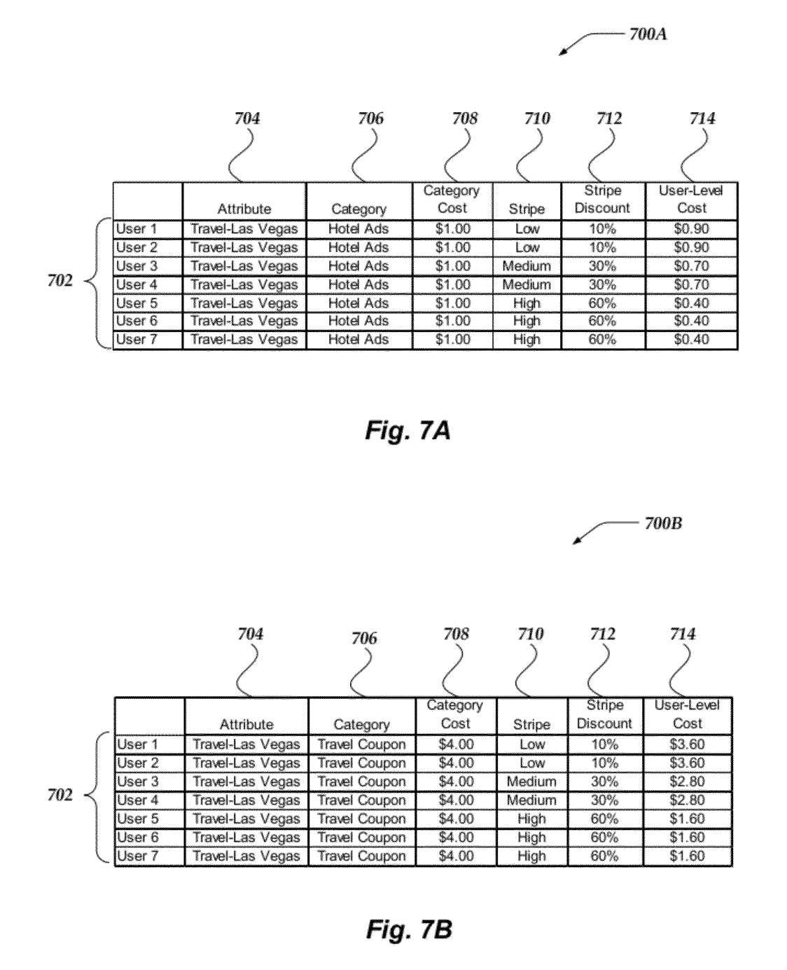

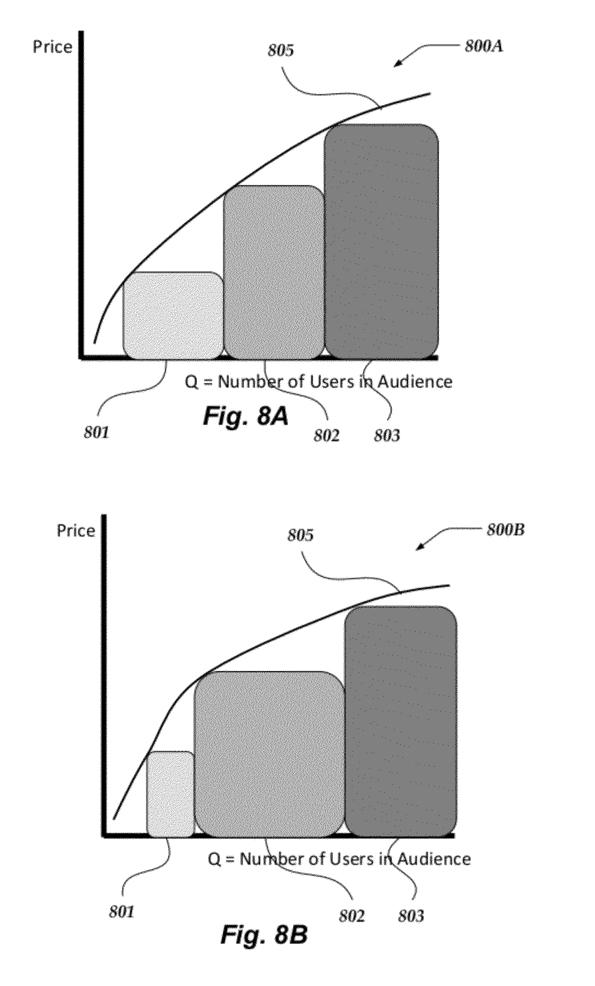

Continuing to block 410, all audience data is distributed to one or more data buyers. In some embodiments, all of the audience data may be distributed to a select number of data buyers. In one embodiment, all of the audience data may be distributed to data buyers who may be obligated to provide content to a minimum number of users. In another embodiment, all of the audience data may be distributed to data buyers who pay a minimum fee to obtain the audience data for potential use. In other embodiments, all of the audience data may be distributed to all data buyers. Thus, the audience data is “always on” for the data buyers who receive a distribution of all the audience data. FIG. 7A and FIG. 7B, which is described in more detail below, show non-limiting and non-exhaustive examples of embodiments of a use case illustrating distributed audience data.

Process 400 then proceeds to block 412, where a reporting of usage by the one or more data buyers is received, i.e. reporting shared audience auction bids. Data buyers may use the audience data to provide content to users of the audience. In some embodiments, a use by the data buyer may occur when online content is provided to a user, e.g. an impression, such as a website advertisement. A cost for this kind of use may be referred to as a cost per impression (CPM). In other embodiments, a use by a data buyer may occur when online content is provided to a user and the user interacts with the content, such as clicking on a link in an advertisement. A cost for this kind of use may be referred to as a cost per click (CPC).

When a data buyer uses the audience data to provide users with content, by either CPM or CPC, the data buyer may provide user-level reporting and/or category-level reporting. In some embodiments, a data buyer may report the category of the content provided. In one embodiment, the data buyer reporting may include a number of impressions; a category identifier; and a billing group.

In other embodiments, a data buyer may report at a user-level. In one embodiment, a data buyer may report which users were provided content. In one embodiment, a data buyer may also report the category of the content provided and the users who were provided content. In another embodiment, a data buyer may report a number of uses, impressions or clicks, for each stripe based on the stripes associated with the users that were provided content. In one embodiment, the user-level reporting by a data buyer may include a unique user identifier; a time when content was provided to the user, e.g. when the impression occurred; a category used for the content; and a billing group.

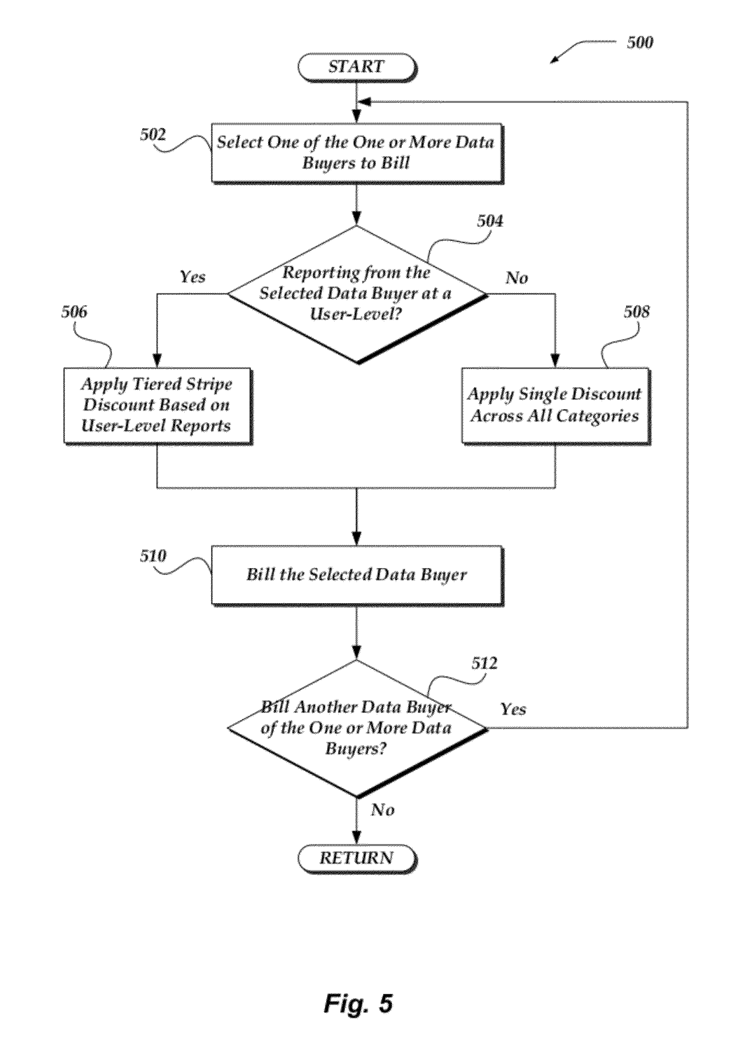

Processing then flows to block 414, which is described below in conjunction with FIG. 5. Briefly, however, at block 414, one or more data buyers are billed for using the audience data based on the reporting of the one or more data buyers. After block 414, process 400 returns to a calling process to perform other actions.

FIG. 5 illustrates a logical flow diagram generally showing one embodiment of a process for billing data buyers. Process 500 of FIG. 5 begins, after a start block, at block 502, where one of the one or more data buyers is selected to be billed. Process 500 then proceeds from block 502 to decision block 504. At decision block 504, a determination is made whether the reports for the selected data buyer are at a user-level. If the reporting is at a user-level, then processing flows to block 506; otherwise, processing flows to block 508.

At block 506, a tiered stripe discount is applied based on the user-level reports. A data buyer reporting at the user-level may include a list of all the users of an audience that were provided content and the category of the content provided. Therefore, for example, a data buyer may report which users were provided an advertisement. Since each user is associated with one of a plurality of stripes and each of the plurality of stripes is assigned a discount, a discount can be applied based on the stripe associated with each user who was provided content.

If the reporting is not at a user-level, then processing flows from decision block 504 to block 508. At block 508, a single discount is applied across all categories. In some embodiments, each category use may have a different set price. In one embodiment, each category use may have a different CPM. In another embodiment, each category use may have a different CPC.

In some embodiments, the single discount applied across all categories may be equivalent to a discount of one of the plurality of stripes within the audience data. In one embodiment, the single discount may be equivalent to the smallest stripe discount of all discounts assigned to the plurality of stripes. In other embodiments, the single discount applied across all categories may be smaller than all discounts assigned to the plurality of stripes.

In some embodiments, the discount applied across all categories may be the same for each of the one or more data buyers. In other embodiments, the discount applied across all categories may be different between the one or more data buyers. In yet other embodiments, a single discount may not be applied across all categories; rather each category may have a set price for providing users with content in that category.

From block 506 or block 508, processing flows to block 510 where data buyers are billed. Proceeding to decision block 512, a determination is made whether to bill another data buyer of the one or more data buyers. If another data buyer is to be billed, then processing loops back to block 502 where another one of the one or more data buyers to be billed is selected; otherwise, process 500 returns to a calling process to perform other actions.

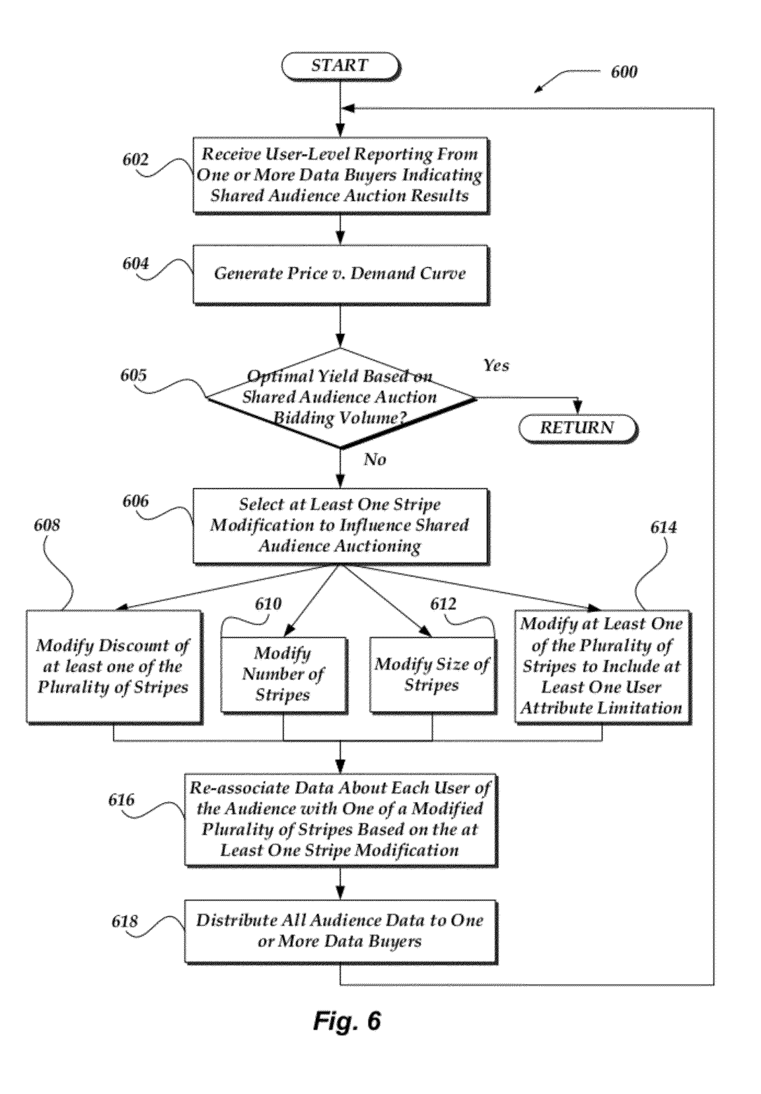

FIG. 6 illustrates a logical flow diagram generally showing one embodiment of a process for dynamically producing an optimum yield based on shared audience auction bidding volume using striped aggressive discounting. In some embodiments, process 600 of FIG. 6 may be implemented by and/or executed on a single network device, such as network device 300 of FIG. 3. In other embodiments, process 600 or portions of process 600 of FIG. 6 may be implemented by and/or executed on a plurality of network devices, such as network device 300 of FIG. 3.

Process 600 begins, after a start block, at block 602, where user-level reporting from one or more data buyers that indicates shared audience auction results is received. Block 602 may employ embodiments of block 412 of FIG. 4 to receive the user-level reporting from the one or more data buyers.

Process 600 then proceeds to block 604, where a price versus demand curve is generated. In some embodiments, the price versus demand curve may differ based on a number, size, and price of each of the plurality of stripes. In other embodiments, the price versus demand curve may differ, where the demand may be based on a shared audience auction bid volume for each of the plurality of stripes. The shared audience auction bid volume may be a total number of users from one of the plurality of stripes who were provided content from all of the one or more data buyers. Each user from the plurality of stripes may have been provided content more than one time from one or more of the one or more data buyers, which may be included in the shared audience auction bid volume. In one embodiment, the shared audience auction bid volume may include a total number of users who were provided content, regardless of a number of times each user was provided content.

Processing next continues at decision block 605. At decision block 605, a determination is made whether a shared audience auction bidding volume using striped aggressive discounting produces an optimum yield based on the price versus demand curve. If the shared audience auction bidding volume produces an optimum yield, then process 600 returns; otherwise, processing flows to block 606. In some embodiments, an optimum yield may be determined based on a maximum threshold value for the area under the price versus demand curve. In other embodiments, an optimum yield may be determined based on a shared audience auction bidding volume of each of a plurality of stripes. In one embodiment, an optimum yield may be determined when the shared audience auction bidding volume for each of the plurality of stripe is above a threshold value.

In some embodiments, the threshold value for the area under the price versus demand curve and/or the threshold value of each of the plurality of stripes may be determined using a statistical analysis approach based on the number, size, and discount of each of the plurality of stripes. In one embodiment, game theory may be employed to determine threshold values. In another embodiment, a Nash equilibrium approach may be employed to determine threshold values. In other embodiments, the threshold value of each of the plurality of stripes may be based on a predetermined condition, such as the shared audience auction bidding volume of each of the plurality of stripes is more than a percentage of the size of a corresponding stripe.

If a shared audience auction bidding volume using striped aggressive discounting does not produce an optimum yield based on the threshold value(s), then processing flows from decision block 605 to block 606. At block 606, a selection of at least one characteristic of at least one stripe to be modified that may influence the shared audience auction is made. The selection of the at least one characteristic of at least one stripe to be modified may be made from block 608, block 610, block 612, and/or block 614. Block 608, block 610, block 612, and block 614 may be performed independent of each other or in any combination thereof.

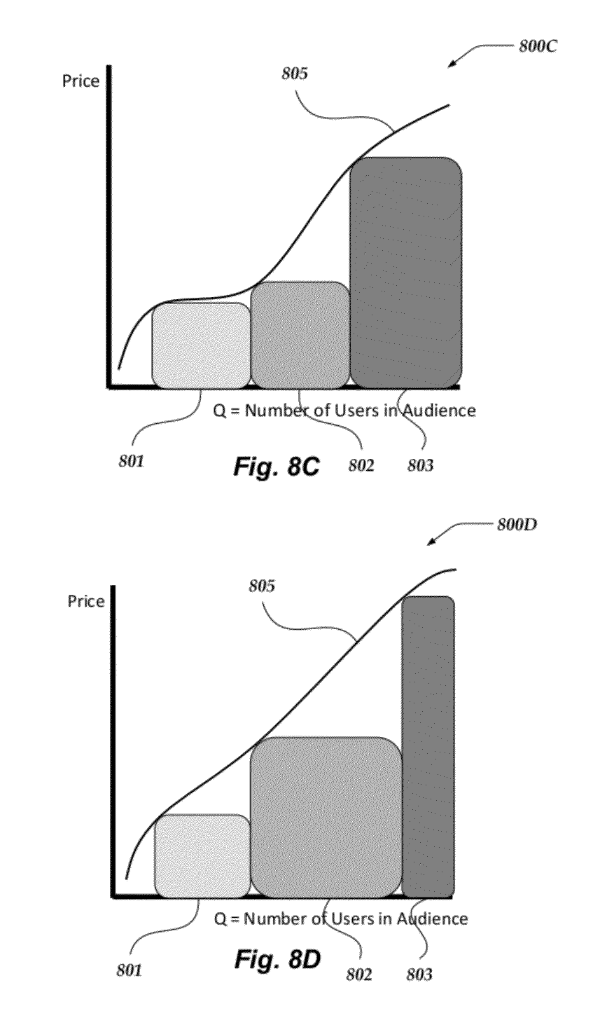

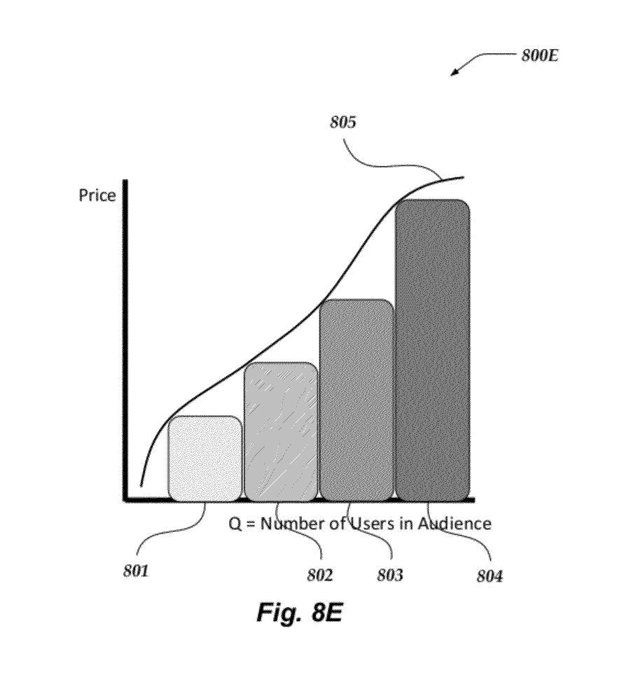

FIGS. 8B-8E, which are described in more detail below, show various non-limiting and non-exhaustive examples of embodiments of a use case illustrating modifications to striped aggressive discounting characteristics. Briefly, FIG. 8A shows one embodiment where the size of the plurality of stripes may be evenly distributed. FIG. 8B shows one embodiment where the size of at least one of the plurality of stripes may be modified compared to the embodiment shown in FIG. 8A. FIG. 8C shows one embodiment where the discount of at least one of the plurality of stripes may be modified compared to the embodiment shown in FIG. 8A. FIG. 8D shows one embodiment where the size of at least one of the plurality of stripes and the discount of at least one of the plurality of stripes may be modified compared to the embodiment shown in FIG. 8A. FIG. 8E shows one embodiment where the total number of the plurality of stripes may be modified compared to the embodiment shown in FIG. 8A.

In any event, continuing at block 608, a discount of at least one of the plurality of stripes is modified. In some embodiments, block 608 may employ embodiments of block 406 of FIG. 4 to modify the discount of at least one of the plurality of stripes.

In some embodiments, if a shared audience auction bidding volume for at least one of the plurality of stripes is above a maximum threshold, then the discount of the at least one of the plurality of stripes may be decreased. This decrease in the discount of the at least one of the plurality of stripes may result in a decrease in the shared audience auction bidding volume for that stripe, which in turn may result in an increase in a shared audience auction bidding volume of another stripe and an increase in the yield. The maximum threshold and a minimum threshold may be determined in a manner similar to determining the optimum yield threshold values for each of the plurality of stripes.

In other embodiments, if a shared audience auction bidding volume for at least one of the plurality of stripes is below a minimum threshold, then the discount of the at least one of the plurality of stripes may be increased. This increase in the discount of the at least one of the plurality of stripes may result in an increase in the shared audience auction bidding volume for that stripe, which in turn may result in an increase in the yield. The maximum threshold and the minimum threshold may be determined in a manner similar to determining the optimum yield threshold values for each of the plurality of stripes.

At block 610, a total number of the plurality of stripes is modified. In some embodiments, block 610 may employ embodiments of block 404 of FIG. 4 to modify the total number of the plurality of stripes.

In some embodiments, if a shared audience auction bidding volume for at least one of the plurality of stripes is below a minimum threshold, then the total number of stripes may be decreased. This decrease in the total number of stripes may result in an increase or decrease in a shared audience auction bidding volume for each of the plurality of stripes, but overall may result in an increase in the yield.

In other embodiments, if a shared audience auction bidding volume for at least one of the plurality of stripes is above a maximum threshold, then the total number of stripes may be increased. This increase in the total number of stripes may result in an increase or decrease in a shared audience auction bidding volume for each of the plurality of stripes, but overall may result in an increase in the yield. The maximum threshold and the minimum threshold may be determined in a manner similar to determining the optimum yield threshold values for each of the plurality of stripes.

At block 612, a size of at least one of the plurality of stripes is modified. In some embodiments, block 612 may employ embodiments of block 404 of FIG. 4 to modify the size of the at least one of the plurality of stripes.

In some embodiments, if a shared audience auction bidding volume for at least one of the plurality of stripes is below a minimum threshold, then the size of the at least one of the plurality of stripes may be decreased. This decrease in the size of the at least one of the plurality of stripes may result in an increase in the size of another stripe, which in turn may result in an increase in a shared audience auction bidding volume of the other stripe and an increase in the yield.

In other embodiments, if a shared audience auction bidding volume for at least one of the plurality of stripes is above a maximum threshold, then the size of the at least one of the plurality of stripes may be increased. This increase in the size of the at least one of the plurality of stripes may result in an increase, in the shared audience auction bidding volume for the at least one of the plurality of stripes and an increase in the yield. The maximum threshold and the minimum threshold may be determined in a manner similar to determining the optimum yield threshold values for each of the plurality of stripes.

At block 614, at least one of the plurality of stripes is modified to include at least one user attribute limitation. In some embodiments, if a shared audience auction bidding volume for at least one of the plurality of stripes is below a minimum threshold, then the at least one of the plurality of stripes may be modified so that users associated with the at least one of the plurality of stripes share an additional attribute that is not shared by users in another stripe. For example, users who search for airline flights to Las Vegas, Nev. more than one time in the past month may be associated with one stripe, and all other users who searched for Las Vegas only one time in the last month may be associated with another stripe. The addition of an attribute limitation may result in an increase in the shared audience auction bidding volume for the modified at least one of the plurality of stripes and an increase in the yield. The minimum threshold, and/or a maximum threshold may be determined in a manner similar to determining the optimum yield threshold values for each of the plurality of stripes.

Continuing to block 616, data about each of the plurality of users of the audience are re-associated with one of a modified plurality of stripes based on the at least one stripe modification. Block 616 may be an embodiment of block 408 of FIG. 4. Process 600 then proceeds from block 616 to block 618. At block 618, all audience data is distributed to the one or more data buyers. Block 618 may be an embodiment of block 410 of FIG. 4. Processing then loops to block 602, where other user-level reporting from one or more data buyers is received.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

### Use Case Illustrations

FIG. 7A and FIG. 7B show one non-limiting and non-exhaustive example of an embodiment of a use case illustrating distributed audience data. Audience data 700A will be described in conjunction with the example below, which includes users 702, attribute 704, category 706, category cost 708, stripe 710, stripe discount 712, and user-level cost 714.

Audience data 700A may include audience data that is distributed to data buyers for category 406, such as hotel advertisements. Thus, audience data 700A may be used by data buyers to provide hotel advertisements to users 702. Audience data 700E of FIG. 7B may be an embodiment of audience data 700A of FIG. 7A. Although audience data 700B and audience data 700A are depicted as separate data structures, a single data structure may contain audience data for one audience or audience data for a plurality of audiences. Similarly, a single data structure or a plurality of data structures may be employed to contain audience data for one category or for a plurality of categories. Thus, audience data 700B may be audience data that is distributed to data buyers for category 706, such as travel coupons. Thus, audience data 700B may be used by data buyers to provide travel coupons to users 702.

Audience data 700A and/or Audience data 700B may be generated using a striped aggressive discounting process, such as a portion of process 400 of FIG. 4. Assume audience data 700A (and/or audience data 700B) is packaged to include users 702, which includes User_1, User_2, User_3, . . . , and User_7. Each of users 702 may share attribute 704, which, in this example, may be traveling to Las Vegas, Nev. Next stripes 710 may include three stripes, “Low,” “Medium,” and “High.” Each of stripe 710 may then be assigned a discount, such as stripe discount 712. In this example, the Low stripe is assigned a 10% discount, the Medium stripe is assigned a 30% discount, and High stripe is assigned a 60% discount. Users 702 may be associated with one of stripe 710. In this example, User_1 and User_2 may be associated with the Low stripe; User_3 and User_4, may be associated with the Medium stripe; and User_5, User_6, and User_7 may be associated with the High stripe.

Each of category 706 (either hotel advertisements or travel coupons, in this example) may have a different category cost 708. In this non-limiting example, hotel advertisement of category 706 may have a category cost 708 of $1.00. Further, travel coupon of category 706 may be a category cost of $4.00. In one embodiment, category cost 708 may be the CPM billed to data buyers who report at a category-level (before any additional discounts are applied). User-level cost 714 may be the cost billed to data buyers who report at a user-level. In one embodiment, user-level cost 714 for each of user 702 may be generated by reducing category cost 708 by the corresponding stripe discount 712 for each of user 702.

Audience data 700A and audience data 700B may then be distributed to one or more data buyers, such as “Data Buyer X.” Data Buyer X may provide content to users 702. Thus, Data Buyer X may provide hotel advertisements to User 1, User 4, and User 7. Similarly, Data Buyer X may provide travel coupons to User 2.

After Data Buyer X provides content to users 702, Data Buyer X may then report its usage. If Data Buyer X reports at a category level, such as by category 706, then the report may indicate that three users were provided hotel advertisements and one user was provided a travel coupon. In this non-limiting and non-exhaustive embodiment, if Data Buyer X reports at a category-level, then Data Buyer X may be billed $7.00.

In contrast, if Data Buyer X reports at a user-level, then the report may indicate that User 1, User 4, and User 8 were provided a hotel advertisement and User 2 was provided a travel coupon. In this non-limiting and non-exhaustive embodiment, if Data Buyer X reports at a user-level, then Data Buyer X may be billed $5.60.

FIG. 8A shows one non-limiting and non-exhaustive example of an embodiment of a use case illustrating striped aggressive discounting. In one embodiment, the plurality of stripes may be sized so that there is an even distribution of users associated with each stripe. In this illustration, stripe 802 has a discount that is smaller than stripe 801 and stripe 803 has a discount smaller than stripe 802. A price versus demand curve 805 can be plotted based on the discount of each of the plurality of stripes. In some embodiments, the shared audience auction bidding volume for one of the stripes may not equal the size of the stripe. In other words, the data buyers may report usage that does not provide content to all users associated with that stripe. As a result, the price versus demand curve 805 may be modified based on an average price per user used for each stripe instead of the price per user associated for each stripe. As noted above, similarly, if a shared audience auction bidding volume for at least one of the plurality of stripes is below a minimum threshold or above a maximum threshold, then the striped aggressive discounting and shared audience auctions may not have produced an optimum yield. Therefore, at least one modification to at least one characteristic of at least one of the plurality of stripes may be performed, which is briefly illustrated in FIGS. 8B-8E.

FIG. 8B shows one non-limiting and non-exhaustive example of an embodiment of a use case illustrating modifications to striped aggressive discounting characteristic. In one embodiment, the size of stripe 802 may be increased due to a shared audience auction bidding volume that is above a maximum threshold. As a result, in one embodiment, the size of stripe 801 may consequentially be decreased so that the total number of users in the audience remains constant. Thus, price versus demand curve 805 may change due to the increased size of stripe 802, which in turn may result in an increase in the yield.

FIG. 8C shows one non-limiting and non-exhaustive example of an embodiment of a use case illustrating modifications to striped aggressive discounting characteristic. In one embodiment, the discount of stripe 802 may be increased (i.e. a decrease in price) due to a shared audience auction bidding volume that is below a minimum threshold. This increase in the discount of stripe 802 may result in an increase in the shared audience auction bidding volume for stripe 802. Thus, price versus demand curve 805 may change, which in turn may result in an increase in the yield.

FIG. 8D shows one non-limiting and non-exhaustive example of an embodiment of a use case illustrating modifications to a striped aggressive discount. In one embodiment, the size of stripe 802 may be increased due to a shared audience auction bidding volume of stripe 802 that is above a maximum threshold. Similarly, the size of stripe 803 may be decreased to account for the increase in size of stripe 802. However, the discount of stripe 803 may be decreased due to a shared audience auction bidding volume of stripe 802 that is above a maximum threshold. The increase in size of stripe 802 and the decrease in discount of stripe 803 may result in an increase in the shared audience auction bidding volume of stripe 802 and a decrease in the shared audience auction bidding volume of stripe 803. Thus, price versus demand curve 805 may change, which in turn may result in an increase in the yield.

FIG. 8E shows one non-limiting and non-exhaustive example of an embodiment of a use case illustrating modifications to a striped aggressive discount. In one embodiment, the total number of the plurality of stripes may be modified due to a shared audience auction bidding volume of stripe 802 that is above a maximum threshold. As a result, the shared audience auction bidding volume of stripe 801, 802, 803, and 804 may increase or decrease. Thus, price versus demand curve 805 may change, which in turn may result in an increase in the yield.

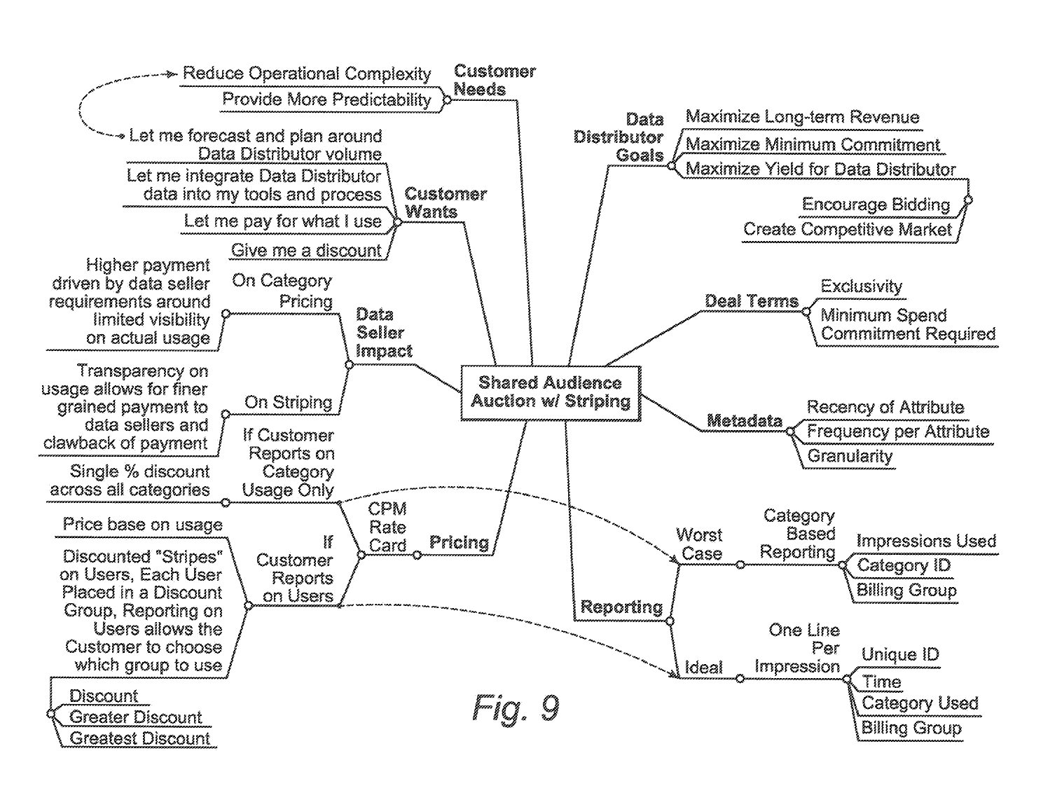

FIG. 9 illustrates one non-limiting and non-exhaustive example of an embodiment of a mapping of an advertising pricing system that uses striped aggressive discounting and shared audience auctions.

“Customer Needs” and “Customer Wants” depict the needs and wants of the data buyers. “BK Goals,” “Deal Terms,” and “MetaData” depict the goals of the entity that distributes the audience data to the data buyers. Further, “Customer Positioning” depicts differences between the concept of category pricing and stripe pricing using the present invention.

The “Reporting” and the “Pricing” depict the employment of the striped aggressive discounting and the reporting of a shared audience auction that. More specifically, “Reporting” depicts two cases of how data buyers report usage, the worst case and the ideal case. The worst case may result when data buyer reporting is at a category-level. The ideal case may result when data buyer reporting is at a user-level. Additionally, “Pricing” depicts how data buyers may be billed based on the reporting. If a customer reports at a category-level then a single percentage discount may be applied across all categories. If a data buyer reports at a user-level then a tiered stripe discounting may be applied.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A method for providing data regarding an audience of users of online content to a plurality of buyers over a network, the method operating on one or more network devices to perform actions, comprising:
partitioning audience data into a plurality of stripes of audience data, wherein each audience data stripe includes a separate subset of the audience data and each audience data stripe is associated with at least one user of the audience;
assigning an initial price discount value to each of the plurality of audience data stripes;
enabling each of the plurality of audience data stripes to be offered for sale in a shared audience auction to the plurality of buyers; and
modifying a characteristic of at least one of the plurality of audience data stripes based on a shared audience auction bidding volume by the plurality of buyers for the at least one of the plurality of stripes.

2. The method of claim 1, wherein at least one of the plurality of audience data stripes is assigned an initial price discount value that is different than another initial price discount value assigned to another one of the plurality of audience data stripes.

3. The method of claim 1, wherein the plurality of audience data stripes is accessible to each of the plurality of buyers independent of another buyer, and each of the plurality of buyers provides a bid independent of the other buyers.

4. The method of claim 1, wherein the shared audience auction bidding volume for at least one audience data stripe indicates if at least one user of the audience has received content from at least one of the plurality of buyers and a frequency that the at least one user has received that content from the at least one of the plurality of buyers.

5. The method of claim 1, further comprising:
increasing a size characteristic of at least one of the plurality of audience data stripes if the shared audience auction bidding volume is equivalent to or greater than a maximum threshold; and
decreasing the size characteristic of the at least one of the plurality of audience data stripes if the shared audience auction bidding volume is equivalent to or less than a minimum threshold.

6. The method of claim 1, further comprising:
increasing the price discount value of at least one of the plurality of audience data stripes if the shared audience auction bidding volume is equivalent to or less than a minimum threshold; and
decreasing the price discount value of the at least one of the plurality of audience data stripes if the shared audience auction bidding volume is equivalent to or greater than a maximum threshold.

7. The method of claim 1, further comprising:
increasing a number of the plurality of audience data stripes if the shared audience auction bidding volume is equivalent to or greater than a maximum threshold for at least one of the plurality of audience data stripes; and
decreasing the number of the plurality of audience data stripes if the shared audience auction bidding volume is equivalent to or less than a minimum threshold.

8. The method of claim 1, further comprising including at least one additional attribute for at least one of the plurality of audience data stripes if the shared audience auction bidding volume is below a minimum threshold.

9. The method of claim 1, further comprising:
receiving a report from at least one buyer that identifies at least one of a category of online content and a user of the audience that was provided online content; and
billing each buyer that wins a bid to use at least one audience data stripe based on a modified price discount value that corresponds to at least one of the category and the user provided online content that were identified in the report.

10. A system for providing data regarding an audience of users of online content to a plurality of buyers over a network, comprising:
a server device, including:
a transceiver device that is operative to communicate over the network;
a memory device that is operative to store at least instructions; and
a processor device that is operative to execute instructions that enable actions, comprising:
partitioning data for the audience of users into a plurality of stripes of audience data, wherein each audience data stripe includes a separate subset of the audience data and each audience data stripe is associated with at least one user of the audience;
assigning an initial price discount value to each of the plurality of audience data stripes;
enabling each of the plurality of audience data stripes to be offered for sale in a shared audience auction to the plurality of buyers that employ at least one client device to communicate with the server device; and
modifying a characteristic of at least one of the plurality of audience data stripes based on a shared audience auction bidding volume by the plurality of buyers for the at least one of the plurality of stripes.

11. The system of claim 10, wherein at least one of the plurality of audience data stripes is assigned an initial price discount value that is different than another initial price discount value assigned to another one of the plurality of audience data stripes.

12. The system of claim 10, wherein the plurality of audience data stripes is accessible to each of the plurality of buyers independent of another buyer, and each of the plurality of buyers provides a bid independent of the other buyers.

13. The system of claim 10, wherein the shared audience auction bidding volume for at least one audience data stripe indicates if at least one user of the audience has received content from at least one of the plurality of buyers and a frequency that the at least one user has received that content from the at least one of the plurality of buyers.

14. The system of claim 10, further comprising:
increasing a size characteristic of at least one of the plurality of audience data stripes if the shared audience auction bidding volume is equivalent to or greater than a maximum threshold; and
decreasing the size characteristic of the at least one of the plurality of audience data stripes if the shared audience auction bidding volume is equivalent to or less than a minimum threshold.

15. The system of claim 10, further comprising:
increasing the price discount value of at least one of the plurality of audience data stripes if the shared audience auction bidding volume is equivalent to or less than a minimum threshold; and
decreasing the price discount value of the at least one of the plurality of audience data stripes if the shared audience auction bidding volume is equivalent to or greater than a maximum threshold.

16. The system of claim 10, further comprising:
increasing a number of the plurality of audience data stripes if the shared audience auction bidding volume is equivalent to or greater than a maximum threshold for at least one of the plurality of audience data stripes; and
decreasing the number of the plurality of audience data stripes if the shared audience auction bidding volume is equivalent to or less than a minimum threshold.

17. The system of claim 10, further comprising including at least one additional attribute for at least one of the plurality of audience data stripes if the shared audience auction bidding volume is below a minimum threshold.

18. The system of claim 10, further comprising:
receiving a report from at least one buyer that identifies at least one of a category of online content and a user of the audience that was provided online content; and
billing each buyer that wins a bid to use at least one audience data stripe based on a modified price discount value that corresponds to at least one of the category and the user provided online content that were identified in the report.

19. A processor readable non-transitive storage media that includes instructions for providing data regarding an audience of users of online content to a plurality of buyers over a network, the execution of the instructions by a processor enables actions, comprising:
partitioning audience data into a plurality of stripes of audience data, wherein each audience data stripe includes a separate subset of the audience data and each audience data stripe is associated with at least one user of the audience;
assigning an initial price discount value to each of the plurality of audience data stripes;
enabling each of the plurality of audience data stripes to be offered for sale in a shared audience auction to the plurality of buyers; and
modifying a characteristic of at least one of the plurality of audience data stripes based on a shared audience auction bidding volume by the plurality of buyers for the at least one of the plurality of stripes.

20. The media of claim 19, wherein at least one of the plurality of audience data stripes is assigned an initial price discount value that is different than another initial price discount value assigned to another one of the plurality of audience data stripes.

21. The media of claim 19, wherein the plurality of audience data stripes is accessible to each of the plurality of buyers independent of another buyer, and each of the plurality of buyers provides a bid independent of the other buyers.

22. The media of claim 19, wherein the shared audience auction bidding volume for at least one audience data stripe indicates if at least one user of the audience has received content from at least one of the plurality of buyers and a frequency that the at least one user has received that content from the at least one of the plurality of buyers.

23. The media of claim 19, further comprising:
increasing a size characteristic of at least one of the plurality of audience data stripes if the shared audience auction bidding volume is equivalent to or greater than a maximum threshold; and
decreasing the size characteristic of the at least one of the plurality of audience data stripes if the shared audience auction bidding volume is equivalent to or less than a minimum threshold.

24. The media of claim 19, further comprising:
increasing the price discount value of at least one of the plurality of audience data stripes if the shared audience auction bidding volume is equivalent to or less than a minimum threshold; and
decreasing the price discount value of the at least one of the plurality of audience data stripes if the shared audience auction bidding volume is equivalent to or greater than a maximum threshold.

25. The media of claim 19, further comprising:
increasing a number of the plurality of audience data stripes if the shared audience auction bidding volume is equivalent to or greater than a maximum threshold for at least one of the plurality of audience data stripes; and
decreasing the number of the plurality of audience data stripes if the shared audience auction bidding volume is equivalent to or less than a minimum threshold.

26. The media of claim 19, further comprising including at least one additional attribute for at least one of the plurality of audience data stripes if the shared audience auction bidding volume is below a minimum threshold.

27. The media of claim 19, further comprising:
receiving a report from at least one buyer that identifies at least one of a category of online content and a user of the audience that was provided online content; and
billing each buyer that wins a bid to use at least one audience data stripe based on a modified price discount value that corresponds to at least one of the category and the user provided online content that were identified in the report.
